(19) United States
(12) Patent Application Publication
(10) Pub. No.: US 2018/0050356 A1
(43) Pub. Date: Feb. 22, 2018

(54) AIR CAP ARRANGEMENT AND SPRAY GUN

(71) Applicant: SATA GmbH & Co. KG, Kornwestheim (DE)

(72) Inventor: Ralf GEHRUNG, Backnang (DE)

(73) Assignee: SATA GmbH & Co. KG, Kornwestheim (DE)

(21) Appl. No.: 15/679,482

(22) Filed: Aug. 17, 2017

(30) Foreign Application Priority Data
Aug. 19, 2016 (CN) 201620911120.1

(51) Int. Cl. B05B 7/08; B05B 15/06

(52) U.S. Cl. CPC B05B 7/083; B05B 15/065

(57) ABSTRACT

An air cap arrangement and a spray gun. The air cap arrangement comprises an air cap, an air cap ring and a retaining ring. The air cap ring comprises a groove configured to extend on the circumferential inner surface of the air cap ring. The air cap also comprises a groove configured to extend on the circumferential outer surface of the air cap, and the retaining ring is arranged in the groove of the air cap ring and the groove of the air cap to limit the axial movement of the air cap within the air cap ring.

### FIELD OF THE DISCLOSURE

The disclosure relates to a spray gun, in particular, to an air cap arrangement for a spray gun and a spray gun with such an air cap.

### BACKGROUND

The spray gun is a tool commonly used in industry, for instance, it may be used to spray paint to surfaces of various articles such as furniture, machines and particularly vehicles, respectively auto bodies. The spray gun can comprise a cup for receiving the paint material and a gun body for spraying the paint material. The paint cup can be arranged on the upper side, on the lower side or laterally of the spray gun. When the paint cup is arranged on the upper side, the spray gun is called gravity fed, when the cup is on the lower side, it's a suction or pressure fed spray gun and when the spray gun has a lateral cup it's called a side cup spray gun. As an alternative to the cup, the spray gun may comprise a hose connected with a pressure tank or a pump which supplies the spray gun with paint under pressure.

A gravity fed spray gun according to the state of the art is shown in FIG. 1 in sectional view. The spray gun 1 comprises a gun body 2, which includes a handle 21 and an upper gun body 22 with spray gun head 23. Wherein, the spray gun head 23 is connected with an air cap 5. The spray gun is supplied with compressed air via an air connection 3. The spray gun 1 has a cup connection 4, to which a paint cup can be connected. The paint cup contains the paint that is to be sprayed with the spray gun. The paint flows from the paint cup through the paint inlet 41 into the paint channel 42. The paint nozzle 26 of the gun body 2 is sealed by the paint needle 10, whereby the paint cannot leave the spray gun. When the trigger 11 is actuated, the air piston head 13, which seals the air supply 9 against the air channels inside the spray gun body, is moved backwards and away from its seat. By that, the compressed air can flow through the inner air channels to the air nozzle 55 of the air cap 5, which is a circular orifice that surrounds the paint nozzle 26. The compressed air is blown out of the air nozzle 55 under pressure.

When the trigger 11 is pressed in excess of a certain point, also the paint needle 10 is moved backwards, leaves its seat in the paint nozzle 26 and the paint nozzle 26 is opened. The paint in the paint channel 42 can flow out of the paint nozzle 26. The compressed air that is blown out of the air nozzle 55 generates a vacuum that sucks the paint out of the paint nozzle 26. Additionally, the paint is pressed out of the nozzle by the following paint. The paint flows in direction of the nozzle because of gravity in the case that the spray gun is gravity fed or because of low=pressure when the spray gun is suction fed or because of pressure when the spray gun is pressure fed or when it's supplied with paint from a paint tank via a hose. When the paint flows out of the paint nozzle 55, the paint is atomized and blown into front direction. Here, a substantially cone shaped round spray is generated.

However, for many paint and finishing works, a flat spray is preferred, because a bigger surface can be painted in a shorter time. Moreover, a more uniform and more efficient coating is possible. Thus, most air caps 5 have two lateral horns 53, particularly on the air nozzle, which protrude in direction of the paint spray. These two horns 53 are also supplied with compressed air. The compressed air is set free through one or more horn air nozzles 531 in each horn. In most cases, the nozzles 531 are circular cylindrical bores, but they can also have another shape. Many spray guns have two horn nozzles with different diameters in each horn. The horn air is directed to the paint spray and deforms it from both sides. By that, the paint spray becomes flat. Its cross section becomes smaller in the direction from that the horn air is exposed and bigger in the other both directions, thus a flat spray is formed. The air cap 5 is rotatable around the spray axis. By that, the angle of the flat spray in relation to the spray guns can be changed. In most cases, a vertical spray is desired.

FIG. 2 and FIG. 3 respective show a sectional view of the air cap arrangement and the spray gun head according to the state of the art above. Wherein, the content shown in FIG. 3 is the same as that shown in FIG. 1, but in FIG. 2, the paint nozzle 26, the paint needle 10 and a sealing in the paint inlet 41 are omitted for easier explanation.

The spray gun head consists of a spray gun body head 23 and an air cap arrangement composed of the air cap 5, a cap ring 6 and a retaining ring 7. The air cap 5 comprises two air horns 53 each having one air horn nozzle 531. The air cap ring 6 surrounds the circumferential outside surface of the air cap 5, and is connected with the gun body 2. A step 51 is arranged on the circumferential outside surface of the air cap 5 in which the outer diameter of the step 51 is larger than the outer diameter of the circumferential outside surface of the air cap 5 such that the step 51 protrudes in the radial direction and acts as a stopper for the air cap 5. A protrusion 61 is arranged on the circumferential inner surface of the air cap ring 6 and contacts against a surface of the step 51 towards the front, to prevent the air cap 5 from moving forward with respect to the air cap ring 6. And a groove 52 is also arranged on the circumferential outside surface of the air cap 5, thus through setting the retaining ring 7 in to the groove 52, the situation that the air cap 5 slips backwards and out of the air cap ring 6 can be avoided. Therefore, the step 51 of the air cap 5, the protrusion 61 of the air cap ring 6 and the retaining ring 7 ensure the connection of the air cap 5 and the spray gun head 23, and the air cap 5 is not or hardly moveable along the spray axis. The step 51, the groove 52 and the protrusion 61 are advantageously run over the whole circumference of the air cap 5 or the air cap ring 6 respectively; the retaining ring 7 is advantageously cut at one position.

However, there are still some problems in such connection manner of the air cap 5 and the spray gun 23:

1) Since the retaining ring 7 is provided out of the cap ring 6, foreign matter such as the paint may be attached on the retaining ring 6 or near the retaining ring 6 such that it is difficult to keep the spray gun clean.

2) It is very difficult and hard for the user to remove the air cap 5 from the air cap arrangement, particularly from the air cap ring 6 for cleaning and maintenance, because the retaining ring 7 is sitting in the groove 52 of the air cap 5 very tightly and at least one tool is required for that purpose to pull or push the retaining ring 7 out of the groove 52.

3) As the retaining ring 7 is lying at the air cap 5 in front of the air cap ring 6, the air cap 5 has to be relatively long, i.e. it has to protrude out from the air cap ring 6 relatively far. By that, much material is required for manufacturing the air cap 5 and the air cap 5 becomes heavier.

4) Since the retaining ring 7 is provided out of the cap ring 1, the gun is not aesthetically pleasing.

Furthermore, as shown in FIG. 3, a circular protrusion 54, which surrounds the spray axis, is arranged on the rear surface of the air cap 5, and the outside surface of end of the circular protrusion 54 is formed as a circular cone shape 541. Furthermore, a circular protrusion 27 is also arranged on the paint nozzle 26, and the inner surface of the end of the protrusion 27 is also configured as circular cone 271. The air cap 5 can be aligned with respect to the paint nozzle 26 through making the circular cone 541 of the circular protrusion 54 to contact against the circuit cone 271 of the circular protrusion 27. However, the connection manner of the air cap 5 and the spray gun 23 limits the movement of the air cap 5, and impedes the air cap 5 from aligning with the paint nozzle 26.

### SUMMARY OF THE DISCLOSURE

The disclosure relates to an air cap arrangement and a spray gun that addresses at least some of the issues identified above.

According to one aspect of the disclosure, an air cap arrangement for spray gun comprises an air cap, an air cap ring and a retaining ring, in which the air cap has a circumferential outer surface extending longitudinally, and the air cap ring has a circumferential inner surface extending longitudinally. The air cap ring comprises a groove configured to extend on the circumferential inner surface of the air cap ring; the air cap also comprises a groove configured to extend on the circumferential outer surface of the air cap, and the retaining ring is arranged in the groove of the air cap ring and the groove of the air cap to limit the axial movement of the air cap within the air cap ring.

In some embodiments, the air cap ring further comprises a protrusion configured to protrude radially from the circumferential inner surface of the air cap ring, and the groove of the air cap ring is further configured to extend circumferentially and locate closer to the front end of the air cap ring than the protrusion. The air cap can further comprise a step configured to protrude radially from the circumferential outer surface of the air cap, and the groove of the air cap is configured to extend circumferentially and locate closer to the front end of the air cap than the step. And the front surface of the step can contact against the rear surface of the protrusion.

In an embodiment, the inner surface of the rear end of the air cap ring is provided with a thread.

In an embodiment, the retaining ring is flexible.

In an embodiment, the retaining ring is a polygonal ring.

In an embodiment, the retaining ring is made of elastic material.

In an embodiment, the retaining ring is made of rubber material.

In an embodiment, the rear end of the air cap is provided with a circular protrusion protruding backward, and the end, protruding backward, of the circular protrusion is provided with a circular cone surface.

In an embodiment, the step and the protrusion run over the whole circumference respectively.

In an embodiment, at least one of the step and the protrusion is discontinuous.

In an embodiment, the retaining ring is an entire ring.

In an embodiment, the retaining ring comprises a cut.

According to another aspect of the disclosure a spray gun comprises a gun body and an air cap arrangement, wherein the spray gun head of the gun body is connected with the air cap arrangement, the air cap arrangement comprises an air cap, an air cap ring and a retaining ring, in which a rear rend of the air cap ring is connected with the spray gun head, the air cap has a circumferential outer surface extending longitudinally, and the air cap ring has a circumferential inner surface extending longitudinally. The air cap ring comprises a groove configured to extend on the circumferential inner surface of the air cap ring; the air cap also comprises a groove configured to extend on the circumferential outer surface of the air cap. And the retaining ring is arranged in the groove of the air cap ring and the groove of the air cap to limit the axial movement of the air cap within the air cap ring.

In some embodiments, the air cap ring further comprises a protrusion configured to protrude radially from the circumferential inner surface of the air cap ring, and the groove of air cap ring is further configured to extend circumferentially and locate closer to the front end of the air cap ring than the protrusion. The air cap can further comprise a step configured to protrude radially from the circumferential outer surface of the air cap, and the groove of the air cap is further configured to extend circumferentially and locate closer to the front end of the air cap than the step. And the front surface of the step can contact against the rear surface of the protrusion.

In an embodiment, the inner surface of the rear end of the air cap ring is provided with a thread to be connected with the external thread of the spray gun.

In an embodiment, the retaining ring is flexible.

In an embodiment, the retaining ring is a polygonal ring.

In an embodiment, the retaining ring is made of elastic material.

In an embodiment, the retaining ring is made of rubber material.

In an embodiment, the rear end of the air cap is provided with a first circular protrusion protruding backward, and the end, protruding backward, of the circular protrusion is provided with a circular cone surface. A paint nozzle arranged in the spray gun is provided with a second circular protrusion protruding forward, and the end, protruding forward, of the second circular protrusion is provided with a circular cone surface, contacting against the circular cone surface of the first circular protrusion.

In an embodiment, the step and the protrusion run over the whole circumference respectively.

In an embodiment, at least one of the step and the protrusion is discontinuous. In an embodiment, the retaining ring is an entire ring.

In an embodiment, the retaining ring comprises a cut.

Through the structure of the air cap arrangement of present disclosure, it is easy to remove the air cap from the air cap ring for cleaning; the air cap can readily rotate with the air cap ring to adjust the orientation of the spray flat; the air flow is more stable because it is not disturbed by the retaining ring; and the air cap can be aligned with the paint nozzle. Therefore the air cap arrangement and the spray gun of present disclosure involves advantageous technical effect while overcoming the problem in the prior art.

### BRIEF DESCRIPTION OF THE DRAWINGS

The drawings constitute a portion of the description for further understanding of the present disclosure. These drawings illustrate the embodiments of the present disclosure and explain the principle of the present disclosure together with the description. In the drawings, the same part is represented by the same reference sign. In the drawings,

FIG. 1 is a schematic diagram illustrating a spray gun according to the prior art.

FIG. 2 is an enlarged schematic diagram illustrating a sectional view of the air cap arrangement and the spray gun head according to the prior art.

FIG. 3 is an enlarged schematic diagram illustrating a sectional view of the air cap arrangement and the spray gun head according to the prior art.

FIG. 4 is a disassembling diagram illustrating an air cap arrangement according to Example 1 of present disclosure.

FIG. 5A is a schematic diagram illustrating the air cap according to Example 1 of present disclosure.

FIG. 5B is a schematic diagram illustrating the air cap with the retaining ring according to Example 1 of present disclosure.

FIG. 6A is a schematic diagram illustrating a front view of the air cap ring with the retaining ring according to Example 1 of present disclosure.

FIG. 6B is a schematic diagram illustrating a rear view of the air cap ring with the retaining ring according to Example 1 of present disclosure.

FIG. 7 is a schematic diagram illustrating an assembled air cap arrangement according to Example 1 of present disclosure.

FIG. 8 is a schematic diagram illustrating a sectional view of the air cap arrangement and the spray gun head according to Example 1 of present disclosure.

FIG. 9A is a schematic diagram illustrating the air cap arrangement according to Example 2 of present disclosure.

FIG. 9B is a schematic diagram illustrating the air cap with the retaining ring according to Example 2 of present disclosure.

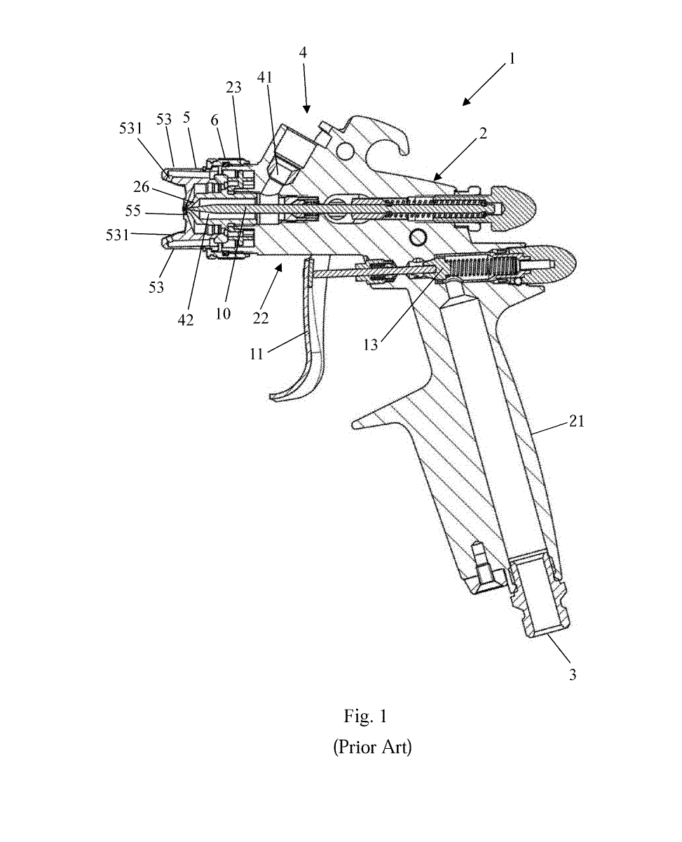

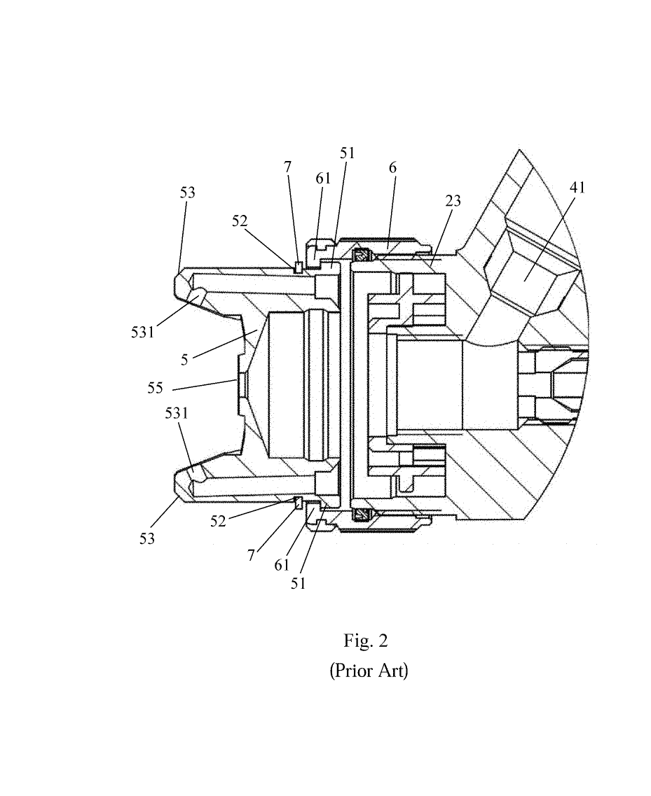

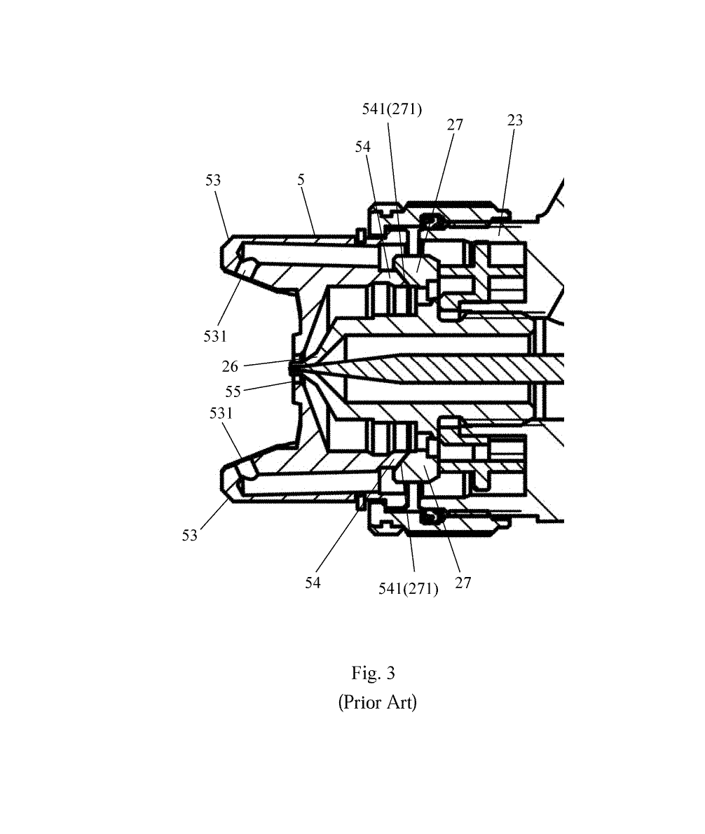

### DETAILED DESCRIPTION

The front direction mentioned herein refers to a direction pointed by the spray gun head, and the rear direction refers to a direction substantially opposite to the front direction; and the up direction mentioned in the present application refers to a direction substantially opposite to the handle direction in a normal hand-held operation state when the handle points downwards. The left side or right side mentioned herein refers to a side of the spray gun or spray gun body corresponding to the operator's left hand or right hand, viewing from the operator's angle, in the normal hand-held operation state when the spray gun head points to the front and the handle points downwards.

### Example 1

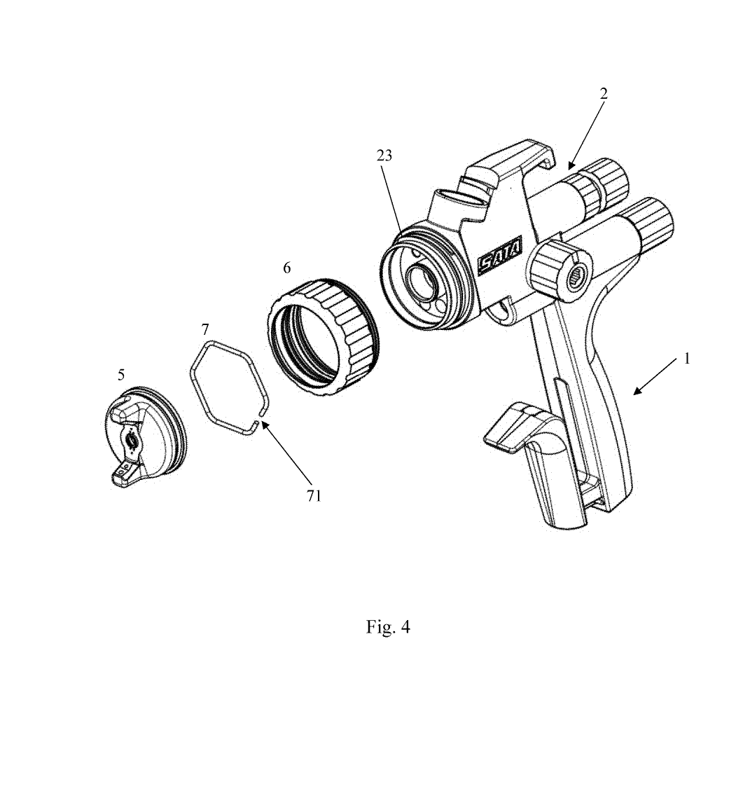

FIG. 4 is a disassembling diagram illustrating an air cap arrangement according to Example 1 of present disclosure. As shown in FIG. 4, the air cap arrangement proposed by Example 1 of present disclosure comprises an air cap 5, an air cap ring 6 and a retaining ring 7 having a cut 71 in this embodiment. The air cap ring 6 is connected with the spray gun head 23 on the gun body 2 of the spray gun 1.

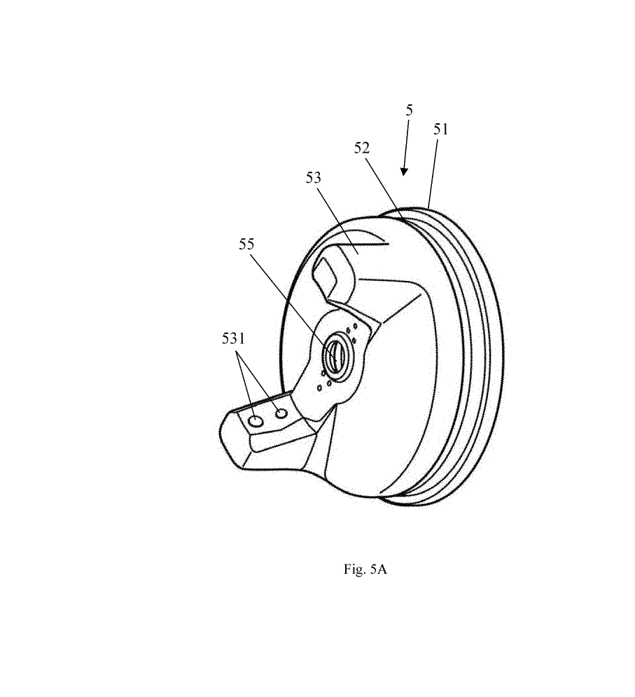

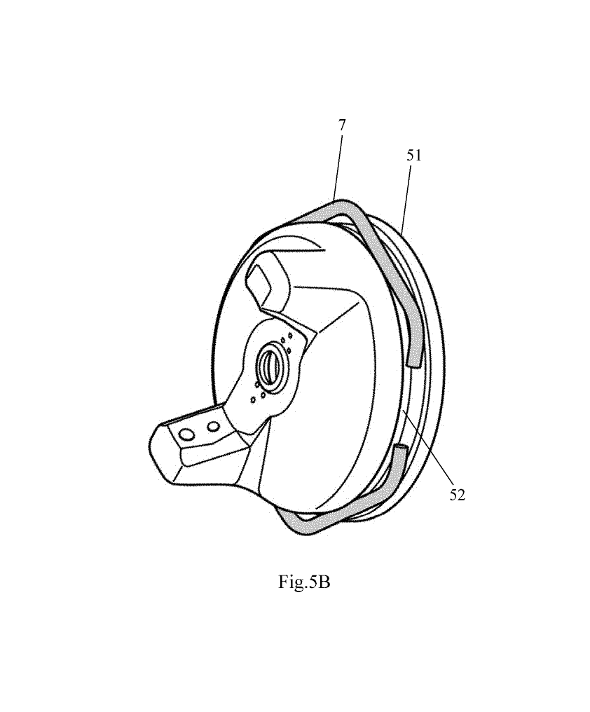

FIG. 5A is a schematic diagram illustrating the air cap according to Example 1 of present disclosure. As shown in FIG. 5A, the front end of the air cap 5 has two two lateral horns 53, and each of the lateral horns 53 comprises horn air nozzle(s) 531. The air cap 5 comprises: a step 51 configured to protrude radially from the circumferential outer surface of the air cap 5; and a groove 52 configured to extend circumferentially on the circumferential outer surface of the air cap 5 and locate closer to the front end of the air cap 5 than the step 51.

FIG. 5B is a schematic diagram illustrating the air cap with the retaining ring according to Example 1 of present disclosure. As shown in FIG. 5B, the retaining 7 can be arranged in the groove 52 of the air cap 5. And since the retaining 7 is polygonal, the contact area between the retaining 7 and the groove 52 is small, thus the friction between them is small.

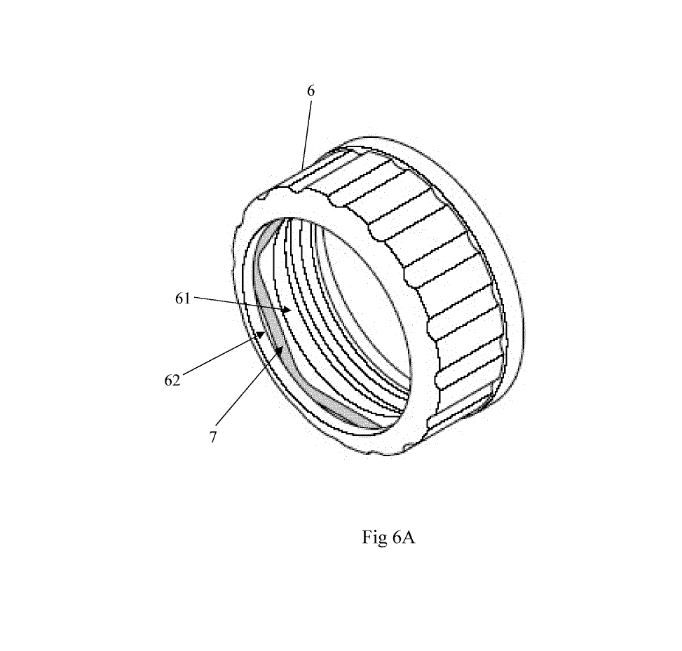

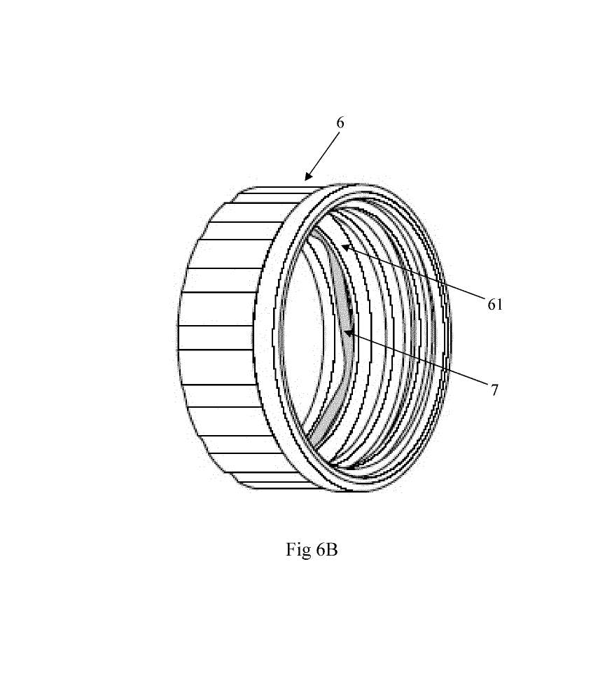

FIG. 6A and FIG. 6B respectively illustrates the front view and rear view of the air cap ring with the retaining ring according to Example 1 of present disclosure. And as shown in FIGS. 6A and 6B, a protrusion 61 is still arranged on the circumferential inner surface of the air cap ring 6. However, the protrusion 61 is located closer to the rear end of the air cap ring 6 than that of the prior art. Furthermore, a groove 62 is arranged on the circumferential inner surface of the air cap ring 6 and closer to the front end of the air cap ring 6 with respect to the protrusion 61. And furthermore, the retaining ring 7 can be arranged in the groove 62 of the air cap ring 6.

As shown in FIGS. 6A and 6B, since the retaining 7 is polygonal, the contact area between the retaining 7 and the groove 62 is small, thus the friction between them is small.

It should be noted that in FIGS. 5B and 6B, both the air cap 5 as well as the air cap ring 6 are equipped with a retaining ring 7, only to show the position of the retaining ring 7 in the groove 52 and the groove 62 when the air cap 5 and the air cap arrangement is assembled, i.e. when the air cap 5 and the air cap ring 6 are connected. However, the assembled air cap arrangement preferably comprises just one single retaining ring 7. However, of course it can also comprise several retaining rings arranged in several grooves.

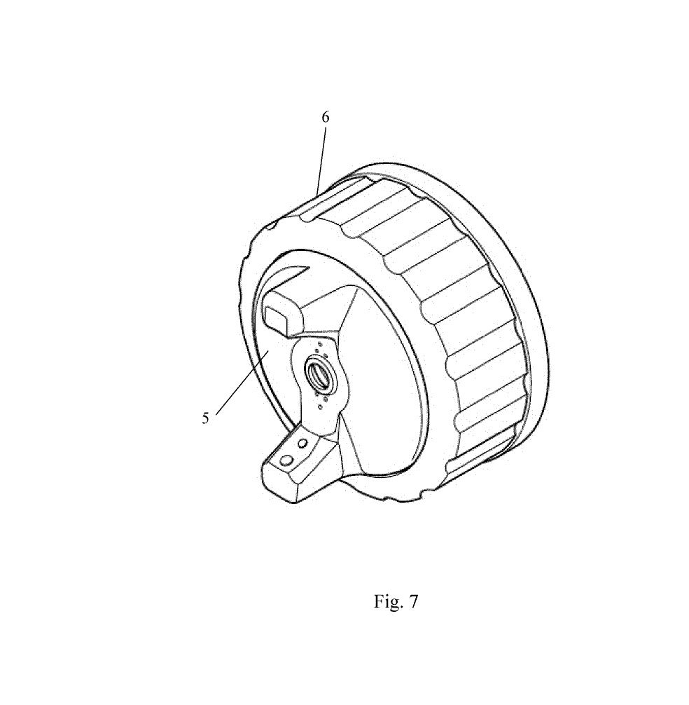

The air cap 5 can be inserted from the rear end of the air cap ring 6 arranged with the retaining ring 7, to form the air cap arrangement, as shown in FIG. 7. As an alternative to this preferred solution, it can be provided that the air cap 5 can be equipped with the retaining ring 7 before inserting it from the from the rear end of the air cap ring 6.

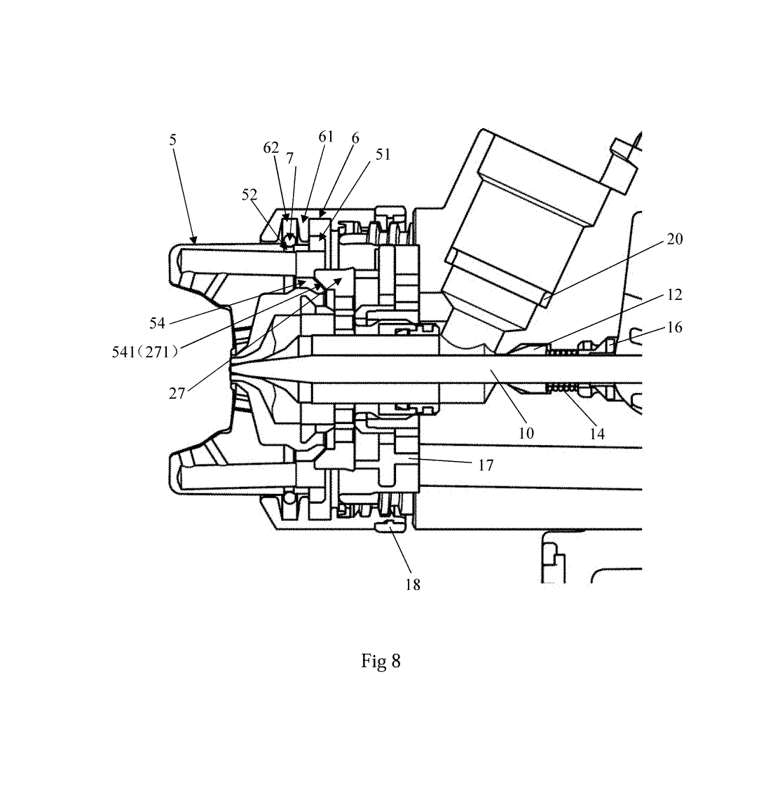

FIG. 8 is a schematic diagram illustrating a sectional view of the air cap arrangement and the spray gun head according to Example 1 of present disclosure. As shown in FIG. 8, the front surface of the step 51 can contact against the rear surface of the protrusion 61 of the air cap ring 6 to prevent the air cap 5 from moving forward with respect to the air cap ring 6.

Furthermore, since the groove 52 is located in front of the step 51, when the air cap 5 is inserted into the air cap ring 6 from the rear of the air cap ring 6, the retaining ring 7 disposed in the groove 62 will enter the groove 52 of the air cap 5. Thus the retaining ring 7 can prevent the air cap 5 from moving backward with respect to the air cap ring 6.

Thus, in the air cap ring arrangement above, the air cap 5 can rotate in the air cap ring 6 around the spray axis, and the air cap 5 is not or hardly moveable in the direction of spray axis.

The step 51, the groove 52 and the protrusion 61 advantageously run over the whole circumference of the air cap 5 or the air cap ring 6 respectively; the retaining ring 7 is advantageously cut 71 at one position, As shown in FIGS. 4 and 5B.

Since the retaining ring 7 is flexible to some extent, the air cap 5 can be pressed out only by pressing the air cap 5 toward the rear end of the air cap ring 6 when the user wants to remove the air cap 5 from the air cap ring 6. Therefore, compared to prior art, it is easy to remove the air cap 5 from the air cap ring 6 and clean it.

As shown in FIGS. 4 and 5B, since the retaining ring 7 comprises a cut 71, the retaining ring 7 may be more flexible to make it easier to remove air cap 5 from the air cap ring 6.

Furthermore, since the retaining ring 7 is arranged in the air cap ring 6 rather than exposed to outside, therefore the foreign matter is prevented from attaching on or near the retaining ring 7 such that the spray gun is kept clean.

Furthermore, as shown in the FIG. 8, retaining ring 7 is arranged in the air cap ring 6, thus it is unnecessary to protrude the air cap 5 out of the air cap ring 6 too far, thus the length of the air cap 5 is reduced such that the weight of the air cap 5 is reduced and the material is saved. And since the retaining ring 7 is arranged in the air cap ring 6, the spray gun is aesthetically pleasing.

Furthermore, as shown in FIGS. 4 and 5B, the retaining ring 7 is a hexagonal ring, thus the contact area between the retaining ring 7 and the groove 62 of the air cap ring 6 is small, and the contact area between the retaining ring 7 and the groove 52 of the air cap 5 is also small. Thus, the friction between the retaining ring 7 and the air cap ring 6 and the friction between the retaining ring 7 and the air cap 5 are both small, so that the air cap 5 can readily rotate with respect to the air cap ring 6 to adjust the orientation of the spray flat. At the same time, as it is already the case with spray guns according to the state of the art, the air cap 5 is fixed when the air cap ring 6 is screwed tight to the spray gun head 23, so that the orientation of the flat spray is fix and cannot be changed unintentionally.

Furthermore, as shown in FIG. 8, since the retaining ring 7 is arranged in the groove 52 disposed on the circumferential outside surface of the air cap 5, thus the retaining ring 7 doesn't lie within the air path. Thus, the flow of the air is not disturbed so that the flow of the air can be kept stable.

Furthermore, as shown in FIG. 8, a circular protrusion 54, which surrounds the spray axis, is arranged on the rear surface of the air cap 5, and the outside surface of end of the circular protrusion 54 is formed as a circular cone surface 541. A circular protrusion 27 is also arranged on the paint nozzle 26, and the inner surface of the end of the protrusion 27 is also configured as circular cone surface 271. The air cap 5 can be aligned with respect to the paint nozzle 26 through making the circular cone surface 541 of the circular protrusion 54 to contact against the circuit cone surface 271 of the circular protrusion 27. In the state of the art, the connection manner of the air cap 5 and the spray gun head 23 limits the movement of the air cap 5, and impedes the air cap 5 from aligning with the paint nozzle 26. However, with the present disclosure, since the retaining ring 7 is not lying tightly in the groove 62, but has space (As shown in FIG. 8), it doesn't impede the air cap 5 from aligning with the paint nozzle 26.

The spray gun according to the present disclosure and a spray gun having an air cap arrangement according to the present disclosure may further have a paint needle 10, a needle sealing arrangement comprising a sealing element 12, a pressure spring 14 and a fixing element 16. The sealing arrangement seals the paint conducting channel in the spray gun body against the outer areas. The paint needle 10 is sliding within the axial symmetrical sealing element 12 when the spray gun is activated, i.e. when the trigger is pulled, by which the sealing element wears out. However, due to the pressure spring 14, which lies against the fixing element 16 and presses against the sealing element 12, the sealing element 12 always lies in its seat tightly. The spray gun can further comprise an air distribution ring 17, a colored marking ring 18, a sealing element 20 in the paint cup connection, a hook, a pressure measuring device and other components known in the state of the art.

Accordingly, through the structure of the air cap arrangement of present Example 1, it is easy to remove the air cap 5 from the air cap ring 6 for cleaning; the air cap 5 can readily rotate with the air cap ring 6 to adjust the orientation of the spray flat; the air flow is more stable because it is not disturbed by the retaining ring 7; and the air cap 5 can be aligned with the paint nozzle 26 more precisely. Therefore, the air cap arrangement of Example 1 involves advantageous technical effect while overcoming the problem in the prior art.

However, the example described above is only used to explain the disclosure, but should not be viewed as the limitation to the disclosure. For example, although the retaining ring 7 used in the Example 1 is hexagon, the retaining ring 7 can also be any other polygonal ring with different number of edges, such as pentagon and heptagon. Furthermore, although the retaining ring 7 in the above Example 1 comprises a cut at the position 71, the retaining ring 7 can also be an entire ring. Although the step 51 and the protrusion 61 in the Example 1 run over the whole circumference of the air cap 5 or the air cap ring 6, the step 51 and/or the protrusion 61 can be discontinuous, as long as they may prevent the air cap 5 from moving forward.

### Example 2

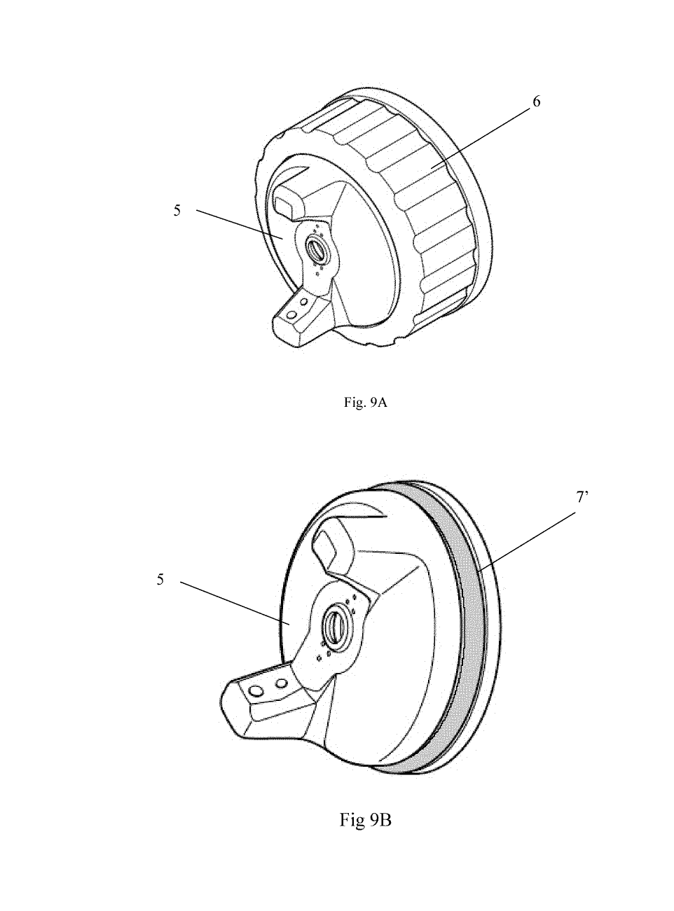

FIG. 9A is a schematic diagram illustrating the air cap arrangement according to Example 2 of present disclosure. And FIG. 9B illustrates a schematic diagram of an air cap 5 and retaining ring 7′ according to Example 2 of present disclosure.

As shown in FIGS. 9A and 9B, the air cap arrangement described in Example 2 is substantively similar to that of Example 1, and the difference only lies in the retaining ring 7′ used in Example 2 and the ring 7 described in Example 1.

As shown in FIG. 9B, the retaining ring 7′ used in Example 2 is a elastic holding ring made of rubber or other elastic material. Similar technical effect as that of Example 1 can be achieved through arranging the retaining ring 7′ in the grooves of the air cap ring 6 and the air cap 5 (not shown). In this Example, it is preferred to first arrange the retaining ring 7′ into the groove 52 of the air cap 5 and then insert the air cap 5 from the rear end of the air cap ring 6 into the air cap ring 6 to form the air cap arrangement. However, it can of course also be provided to first arrange the retaining ring 7′ into the groove 62 of the air cap ring 6 and then insert the air cap 5.

And preferably, the retaining ring 7′ is an entire circular ring. However, as for present disclosure, the retaining ring 7′ can be cut to increase its flexibility. Furthermore, the retaining ring 7′ can also be configured as a polygonal ring as described in Example 1.

What is claimed is:

1. An air cap arrangement for spray gun, comprising an air cap, an air cap ring and a retaining ring, in which the air cap has a circumferential outer surface extending longitudinally, and the air cap ring has a circumferential inner surface extending longitudinally, wherein
the air cap ring comprises a groove configured to extend on the circumferential inner surface of the air cap ring; the air cap further comprises a groove configured to extend on the circumferential outer surface of the air cap, and
the retaining ring is arranged in the groove of the air cap ring and the groove of the air cap to limit the axial movement of the air cap within the air cap ring.

2. The air cap arrangement according to claim 1, wherein
the air cap ring further comprises a protrusion configured to protrude radially from the circumferential inner surface of the air cap ring,
the groove of the air cap ring is further configured to extend circumferentially and locate closer to the front end of the air cap ring than the protrusion;
the air cap further comprises a step configured to protrude radially from the circumferential outer surface of the air cap,
the groove of the air cap is configured to extend circumferentially and locate closer to the front end of the air cap than the step, and wherein
the front surface of the step can contact against the rear surface of the protrusion.

3. The air cap arrangement according to claim 1, wherein the circumferential inner surface of the rear end of the air cap ring is provided with a thread.

4. The air cap arrangement according to claim 1, wherein the retaining ring is flexible.

5. The air cap arrangement according to claim 4, wherein the retaining ring is a polygonal ring.

6. The air cap arrangement according to claim 4, wherein the retaining ring is made of elastic material.

7. The air cap arrangement according to claim 4, wherein the retaining ring is made of rubber material.

8. The air cap arrangement according to claim 1, wherein the rear end of the air cap is provided with a circular protrusion protruding backward, and the end, protruding backward, of the circular protrusion is provided with a circular cone surface.

9. The air cap arrangement according to claim 2, wherein the step and the protrusion run over the whole circumference respectively.

10. The air cap arrangement according to claim 2, wherein at least one of the step and the protrusion is discontinuous.

11. The air cap arrangement according to claim 1, wherein the retaining ring is an entire ring.

12. The air cap arrangement according to claim 1, wherein the retaining ring comprises a cut.

13. A spray gun, comprising a gun body and an air cap arrangement, wherein the spray gun head of the gun body is connected with the air cap arrangement, the air cap arrangement comprises an air cap, an air cap ring and a retaining ring, in which a rear end of the air cap ring is connected with the spray gun head, the air cap has a circumferential outer surface extending longitudinally, and the air cap ring has a circumferential inner surface extending longitudinally, wherein
the air cap ring comprises a groove configured to extend on the circumferential inner surface of the air cap ring; the air cap further comprises a groove configured to extend on the circumferential outer surface of the air cap, and
the retaining ring is arranged in the groove of the air cap ring and the groove of the air cap to limit the axial movement of the air cap within the air cap ring.

14. The spray gun according to claim 13, wherein
the rear end of the air cap is provided with a first circular protrusion protruding backward, and the end, protruding backward, of the circular protrusion is configured in a circular cone surface,
a paint nozzle arranged in the spray gun is provided with a second circular protrusion protruding forward, and the end, protruding forward, of the second circular protrusion is configured in a circular cone surface, contacting against the circular cone surface of the first circular protrusion.
